(19) United States
(12) Patent Application Publication
(10) Pub. No.: US 2008/0315143 A1
(43) Pub. Date: Dec. 25, 2008

(54) BUTTERFLY VALVES

(75) Inventors: Anthony W. Mendoza, Phoenix, AZ (US); Don J. Atkins, Chandler, AZ (US); Joel E. LaBenz, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/767,986

(22) Filed: Jun. 25, 2007

(51) Int. Cl. F16K 1/22

(52) U.S. Cl. 251/305

(57) ABSTRACT

Butterfly valves are provided that include a flowbody, a butterfly plate, and a coating. The flowbody has an inner surface defining a channel. The butterfly plate is disposed in the channel, is rotationally mounted to the flowbody, and has an outer periphery. The coating is disposed on at least a portion of at least one of the flowbody inner surface and the butterfly plate outer periphery and is made of a material formulated to abrade upon friction contact with an adjacent surface and to maintain structural integrity when subjected to pneumatic forces of at least 600 psi.

### TECHNICAL FIELD

The inventive subject matter relates to pneumatic valves and, more particularly, to non-sealing butterfly valves.

### BACKGROUND

Valves may be employed in any one of numerous situations. For example, non-sealing valves may be used in an air distribution system to direct airflow from one portion of an aircraft to another. In this regard, pneumatic valves may be disposed in a duct between an air source and one or more outlets for exhausting the received air to desired areas within the aircraft, such as, for example, to an aircraft cabin or an underfloor section of the aircraft.

One exemplary type of non-sealing pneumatic valve that has been employed in aircraft is a butterfly valve. A butterfly valve is typically made up of a valve flowbody and a butterfly plate. The valve flowbody may be made of a rigid material, such as metal, and includes an inner surface defining a channel. The valve flowbody is configured to be disposed between two ducts or disposed in one of the ducts of the air distribution system. The butterfly plate is made of a rigid material as well and is rotationally mounted to the valve flowbody. Conventionally, the butterfly plate is positioned in the channel such that a minimum clearance is formed with the inner surface of the valve flowbody. An actuator and a spring may be used to control the rotation of the butterfly plate.

Typically, the butterfly plate moves between closed, open, and partially open positions. When in the closed position, the butterfly plate substantially blocks the channel to prevent, or at least inhibit, air from flowing therethrough. When air flows through the valve flow body in a forward direction, the butterfly plate moves to the open or partially open position to allow air flow through the channel.

Although the aforementioned valve configuration operates adequately, it may exhibit some drawbacks. For example, over time, the butterfly plate may become displaced, and as a result, repeated contact may occur between the inner surface of the valve flowbody and butterfly plate. Because the valve flowbody and butterfly plate are typically made of metal, they may rub against each other and become worn. In some cases, material making up the worn components may bind together and cause the valve to malfunction.

Accordingly, there is a need for a non-sealing pneumatic valve that, in the event the butterfly plate contacts the valve flowbody, may continue to operate. Moreover, it would be desirable for the valve to have an increased life expectancy, to be lightweight, and to be relatively inexpensive to implement. Furthermore, other desirable features and characteristics of the inventive subject matter will become apparent from the subsequent detailed description and the appended claims, taken in conjunction with the accompanying drawings and the foregoing technical field and background

### BRIEF SUMMARY

Butterfly valves are provided that include a flowbody, a butterfly plate, and a coating.

In an embodiment, by way of example only, the flowbody has an inner surface defining a channel. The butterfly plate is disposed in the channel, is rotationally mounted to the flowbody, and has an outer periphery. The coating is disposed on at least a portion of at least one of the flowbody inner surface and the butterfly plate outer periphery and is made of a material formulated to abrade upon friction contact with an adjacent surface and to maintain structural integrity when subjected to pneumatic forces of at least 600 psi. In another embodiment, by way of example only, the coating is disposed on at least a portion of the flowbody inner surface and is made of a material formulated to abrade upon friction contact with the butterfly plate outer periphery and to maintain structural integrity when subjected to pneumatic forces of at least 600 psi. In still another embodiment, by way of example only, the coating is disposed on at least a portion of the butterfly plate outer periphery and is made of a material formulated to abrade upon friction contact between the flowbody inner surface and the coating and to maintain structural integrity when subjected to pneumatic forces of at least 600 psi.

Other independent features and advantages of the preferred relief plate will become apparent from the following detailed description, taken in conjunction with the accompanying drawings which illustrate, by way of example, the principles of the inventive subject matter.

### BRIEF DESCRIPTION OF THE DRAWINGS

FIG. 1 is a simplified schematic diagram illustrating an exemplary air distribution system disposed within an aircraft, according to an embodiment;

FIG. 2 is a cutaway view of a valve assembly that may be implemented into the air distribution system shown in FIG. 1, according to an embodiment;

FIG. 3 is a cross-sectional view of a portion of the valve assembly shown in FIG. 2 taken along line 3-3, according to an embodiment;

FIG. 4 is a cross section view of a portion of the valve assembly shown in FIG. 2 taken along line 3-3, according to another embodiment; and

FIG. 5 is a cross section view of a portion of the valve assembly shown in FIG. 2 taken along line 3-3, according to still another embodiment.

### DETAILED DESCRIPTION OF A PREFERRED EMBODIMENT

The following detailed description of the inventive subject matter is merely exemplary in nature and is not intended to limit the inventive subject matter or the application and uses of the inventive subject matter. Furthermore, there is no intention to be bound by any theory presented in the preceding background of the inventive subject matter or the following detailed description of the inventive subject matter.

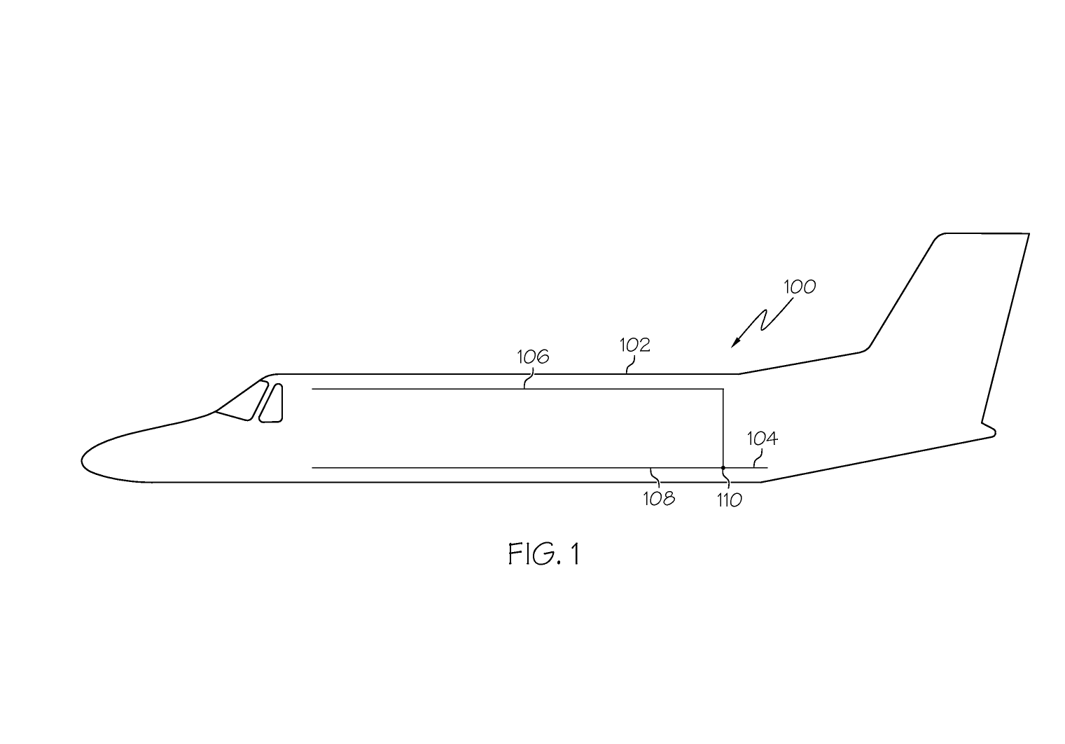

FIG. 1 is a simplified schematic diagram illustrating an air distribution system 100 disposed within an aircraft 102, according to an embodiment. The air distribution system 100 includes an inlet duct 104, two outlet ducts 106, 108 and a valve assembly 110 positioned between the ducts 104, 106, 108. The inlet duct 104 receives air from an air source, such as, for example, engine bleed air, and the outlet ducts 106, 108 exhaust air into desired sections of the aircraft 102. In one exemplary embodiment, the outlet ducts 106, 108 exhaust air into an aircraft underfloor. It will be appreciated that although two outlet ducts 106, 108 are depicted herein, fewer or more outlet ducts may be incorporated into the system 100. The valve assembly 110 regulates air flow through one or more of the outlet ducts 106, 108 by opening or closing in response to the presence or absence of a pressure differential across the valve assembly 110 that exceeds a predetermined value.

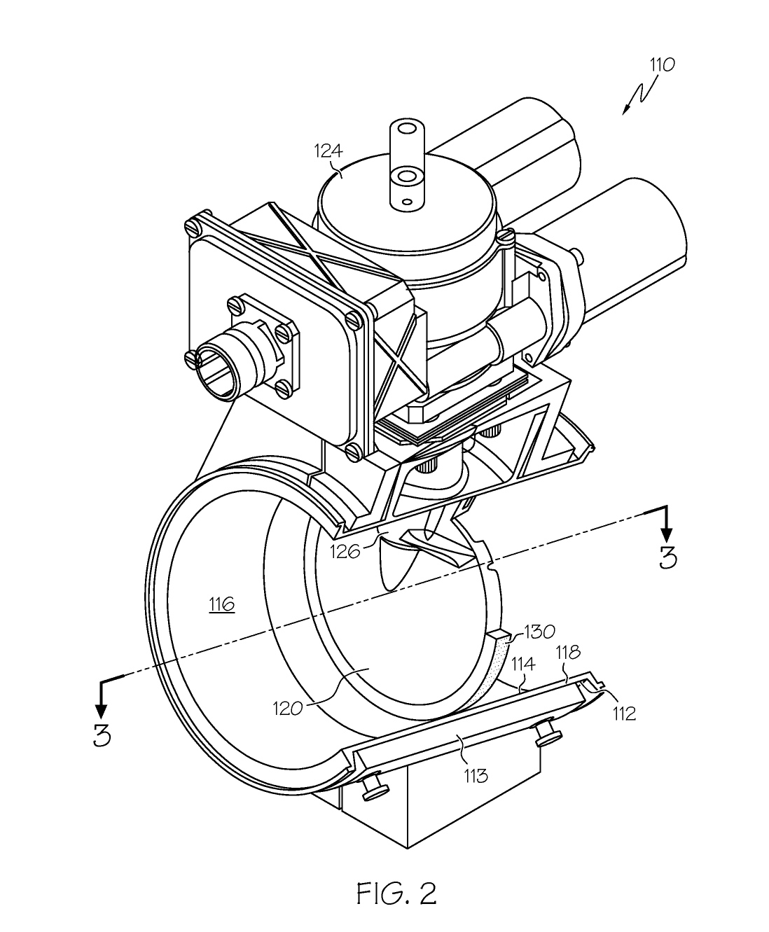

FIG. 2 is a cutaway view of a valve assembly 110 that may be implemented into the air distribution system 100 shown in FIG. 1, according to an embodiment. The valve assembly 110 includes a valve flowbody 112 having an inner surface 114 that defines a channel 116 and an outer surface 118. The valve flowbody 112 is generally made of a metallic material. Examples of suitable materials include aluminum alloys, steel or titanium, to name a few. Although one channel 116 is shown formed in the flowbody 112, it will be appreciated that more may alternatively be incorporated. In an embodiment, the valve flowbody 112 may be surrounded by an insulator 113.

The butterfly plate 120 is disposed in the channel 116 and is rotationally mounted to the flowbody 112. In an embodiment, the butterfly plate 120 may be coupled to an actuator 124 that causes it to selectively open or close. The actuator 124 may be any actuating mechanism, including, but not limited to, an electric actuator, a pneumatic actuator, a hydraulic actuator, or a manual actuator. In another embodiment, the butterfly plate 120 may be biased toward the closed position by a spring 126. In particular, the spring 126 may be coupled to the butterfly plate 120 and may supply a force that urges the butterfly plate 120 toward the closed position.

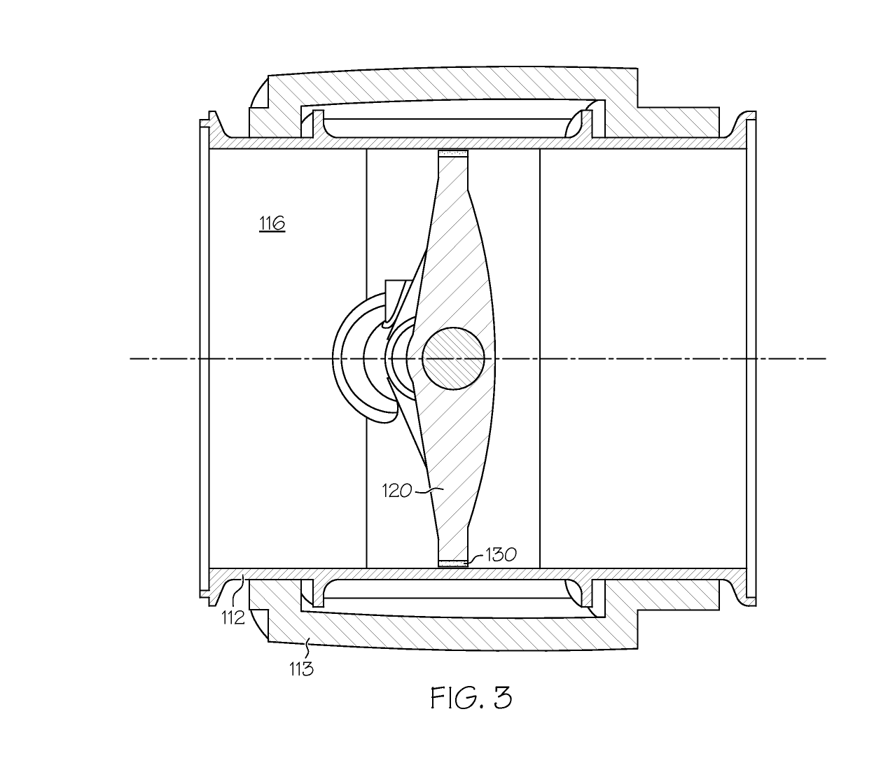

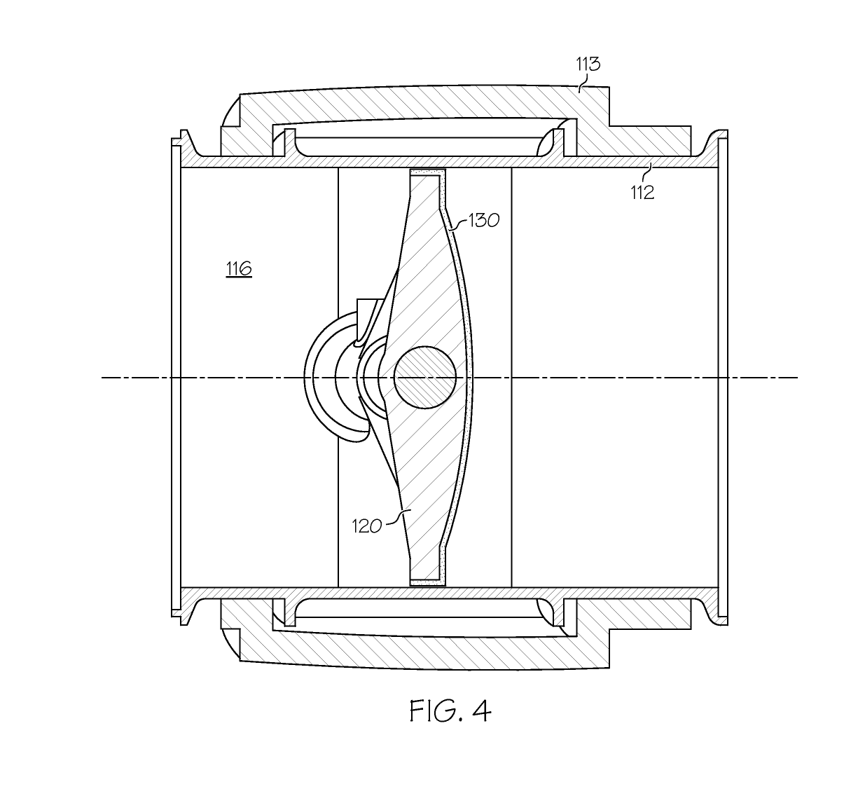

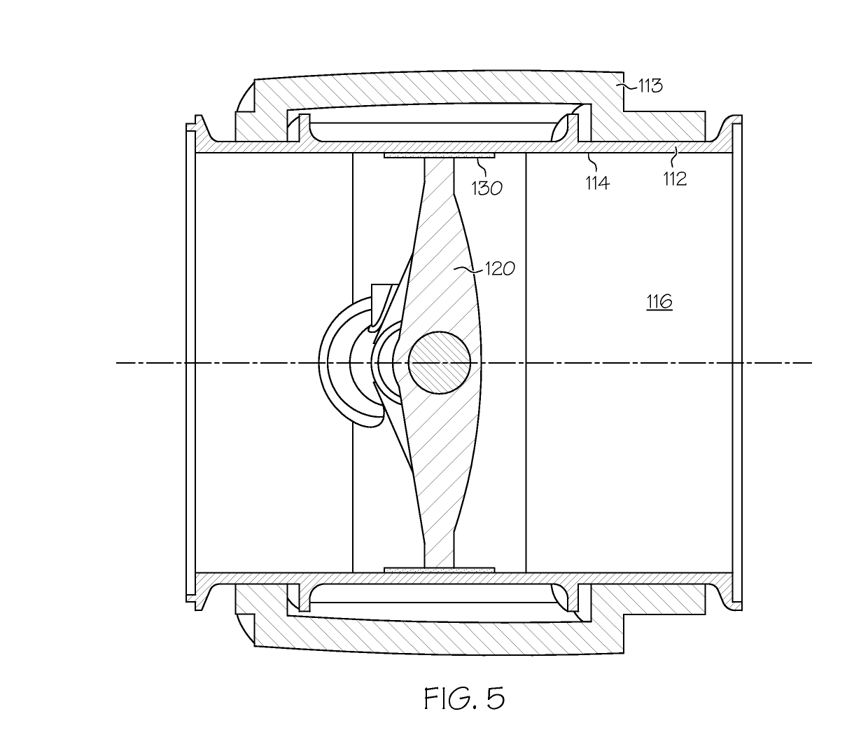

To prevent the valve assembly 110 from prematurely becoming worn, a coating made of an abradable material is disposed on at least a portion of one or both of the butterfly plate 120 and flowbody 112. FIG. 3 is a cross-sectional view of a portion of the valve assembly shown in FIG. 2 taken along line 3-3, according to an embodiment. Here, the butterfly plate 120 is coated and the coating 130 is disposed on an outer periphery of the plate 120. FIG. 4 is a cross-sectional view of a portion of the valve assembly shown in FIG. 2 taken along line 3-3, according to another embodiment. In this embodiment, the coating 130 coats substantially all of the plate 120. In still another embodiment shown in FIG. 5, the coating 130 is included on the flowbody 112, and at least a portion of the flowbody inner surface 114 is coated. In particular, at least areas of the flowbody inner surface 114 that are located radially outward from the butterfly plate 120 and adjacent thereto may be coated. In still other embodiments, as shown in FIG. 1, the coating 130 may coat both the flowbody inner surface 114 and the butterfly plate 120, in other embodiments.

No matter the particular location, the coating 130 may have a thickness of between about 0.01 and 0.25 cm. In an embodiment, a clearance may be maintained between the coating 130 and the uncoated or coated butterfly plate 120 or flowbody inner surface 114. The clearance may be between about 0.002 and 0.150 cm. In other embodiments, the coating 130 and uncoated or coated butterfly plate 120 or flowbody inner surface 114 does not have a clearance therebetween. In these embodiments, an initial tight seal may be provided between the butterfly plate 120 and flowbody inner surface 114; however, over time, the coating 130 abrades to then form a clearance.

The coating 130 is made of a material that is formulated to abrade upon friction contact with an adjacent surface. Friction contact may be defined as a contact between two adjacent surfaces in which one surface is rubbed against the other. In an embodiment, the material is also capable of maintaining structural integrity when subjected to pneumatic forces of at least 600 psi. In another embodiment, the material is additionally selected to be capable of withstanding temperatures in a range of about −195° C. to about 650° C. Examples of materials having the aforementioned characteristics include, but are not limited to mica-filled tetrafluoroethylene, nickel-graphite, aluminum including silicon/polyester resin, silicon elastomer including hollow glass microspheres, and nickel-chromium including polymethyl methacrylate. In an embodiment, the material may have a color that is different than the color of the surface it coats, e.g., the flowbody inner surface 114 or the butterfly plate 120.

During operation, when friction contact occurs between the coating 130 and an adjacent surface, the coating 130 material abrades. In an embodiment, the abraded material does not bind the abraded surfaces together. As a result, the valve assembly 110 may then operate more efficiently and have a longer useful life, as compared with conventional butterfly valves.

In another embodiment, the abraded material forms a powder. The powder may adhere to the adjacent surfaces that have contacted the coating 130, but may not bond to the coating 130. In an embodiment in which the coating 130 material is a different color from the other valve components and only one of the butterfly plate 120 or flowbody inner surface 114 is coated, the colored powder may identify areas of the valve assembly 110 that may need to be adjusted. For example, if the butterfly plate 120 includes the coating 130 and a portion of the flowbody inner surface 114 has colored powder thereon, an indication may exist that the butterfly plate 120 may need to be re-positioned.

A non-sealing pneumatic valve has now been provided that is capable of maintaining a clearance between the inner surface of its valve flowbody and butterfly plate during its useful life. Additionally, the valve may have an increased life expectancy as compared to conventional valves. In addition, the valve may be lightweight and relatively inexpensive to implement.

While the inventive subject matter has been described with reference to a preferred embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

We claim:

1. A butterfly valve, comprising:
a flowbody having an inner surface defining a channel;
a butterfly plate disposed in the channel and rotationally mounted to the flowbody, the butterfly plate having an outer periphery; and
a coating disposed on at least a portion of at least one of the flowbody inner surface and the butterfly plate outer periphery, the coating comprising a material formulated to abrade upon friction contact with an adjacent surface and to maintain structural integrity when subjected to pneumatic forces of at least 600 psi.

2. The butterfly valve of claim 1, wherein the coating is disposed on the flowbody inner surface and the butterfly plate outer periphery.

3. The butterfly valve of claim 1, wherein the coating is disposed on substantially all of the butterfly plate.

4. The butterfly valve of claim 1, wherein the coating material is formulated to withstand temperatures in a range of about −195° C. to about 650° C.

5. The butterfly valve of claim 1, wherein the coating material comprises a material selected from the group consisting of mica-filled tetrafluoroethylene, nickel-graphite, aluminum including silicon/polyester resin, silicon elastomer including hollow glass microspheres, and nickel-chromium including polymethyl methacrylate.

6. The butterfly valve of claim 1, wherein the coating material produces a powder after friction contact between the coating and one of the flowbody inner surface and the butterfly plate outer periphery.

7. The butterfly valve of claim 1, wherein the coating material and the flowbody inner surface are different colors.

8. The butterfly valve of claim 1, wherein the butterfly plate outer periphery and the flowbody inner surface include a clearance therebetween.

9. A butterfly valve, comprising:
a flowbody having an inner surface defining a channel;
a butterfly plate disposed in the channel and rotationally mounted to the flowbody, the butterfly plate having an outer periphery; and
a coating disposed on at least a portion of the flowbody inner surface and comprising a material formulated to abrade upon friction contact with the butterfly plate outer periphery and to maintain structural integrity when subjected to pneumatic forces of at least 600 psi.

10. The butterfly valve of claim 9, wherein the coating material is formulated to withstand temperatures in a range of about −195° C. to about 650° C.

11. The butterfly valve of claim 9, wherein the coating material comprises a material selected from the group consisting of mica-filled tetrafluoroethylene, nickel-graphite, aluminum including silicon/polyester resin, silicon elastomer including hollow glass microspheres, and nickel-chromium including polymethyl methacrylate.

12. The butterfly valve of claim 9, wherein the coating material produces a powder after friction contact between the coating and one of the flowbody inner surface and the butterfly plate outer periphery.

13. The butterfly valve of claim 9, wherein the coating material and the flowbody inner surface are different colors.

14. The butterfly valve of claim 9, wherein the butterfly plate outer periphery and the flowbody inner surface include a clearance therebetween.

15. A butterfly valve, comprising:
a flowbody having an inner surface defining a channel;
a butterfly plate disposed in the channel and rotationally mounted to the flowbody, the butterfly plate having an outer periphery; and
a coating disposed on at least a portion of the butterfly plate outer periphery, the coating comprising a material formulated to abrade upon friction contact between the flowbody inner surface and the coating and to maintain structural integrity when subjected to pneumatic forces of at least 600 psi.

16. The butterfly valve of claim 15, wherein the coating is disposed on substantially all of the butterfly plate.

17. The butterfly valve of claim 15, wherein the coating material is formulated to withstand temperatures in a range of about −195° C. to about 650° C.

18. The butterfly valve of claim 15, wherein the coating material comprises a material selected from the group consisting of mica-filled tetrafluoroethylene, nickel-graphite, aluminum including silicon/polyester resin, silicon elastomer including hollow glass microspheres, and nickel-chromium including polymethyl methacrylate.

19. The butterfly valve of claim 15, wherein the coating material and the flowbody inner surface are different colors.

20. The butterfly valve of claim 15, wherein the butterfly plate outer periphery and the flowbody inner surface include a clearance therebetween.
